(19) United States
(12) Patent Application Publication
(10) Pub. No.: US 2025/0093676 A1
(43) Pub. Date: Mar. 20, 2025

(54) OPTICAL SYSTEM

(71) Applicant: TDK TAIWAN CORP., Taoyuan City (TW)

(72) Inventors: Yi-An LI, Taoyuan City (TW); Yi-Ho CHEN, Taoyuan City (TW)

(21) Appl. No.: 18/884,421

(22) Filed: Sep. 13, 2024

Related U.S. Application Data
(60) Provisional application No. 63/583,067, filed on Sep. 15, 2023.

(51) Int. Cl. G02B 27/64

(52) U.S. Cl. CPC G02B 27/646

(57) ABSTRACT

An optical system includes a fixed assembly, a movable part and a suspension module. The movable part is configured to be connected to an optical module, and the movable part is movable relative to the fixed assembly. The movable part is movable relative to the fixed assembly through the suspension module.

### CROSS REFERENCE TO RELATED APPLICATIONS

This application claims the benefit of U.S. Provisional Application No. 63/583,067, filed on Sep. 15, 2023, the entirety of which is incorporated by reference herein.

### BACKGROUND OF THE INVENTION

### Field of the Disclosure

The present disclosure relates to an optical system, and in particular to an optical system with a shockproof function.

### Description of the Related Art

The development of technology has allowed many of today's electronic devices (such as smartphones) to be equipped with camera modules to provide photographic and video functionality. Users can capture photographs and record videos using the camera modules disposed in their electronic devices.

Today's design of electronic devices continues to follow the trend of miniaturization, meaning that the various components of the camera module and its structure must also be continuously reduced in size, so as to achieve miniaturization. In general, a driving mechanism in a camera module has a camera lens holder configured to hold a camera lens, and the driving mechanism can have the functions of auto focusing and optical image stabilization. However, although the existing driving mechanism can achieve the aforementioned functions of taking photographs and recording videos, they still cannot meet all users' needs.

Therefore, how to design a camera module that can perform optical image stabilization and achieve miniaturization is topic nowadays that needs to be discussed and solved.

### BRIEF SUMMARY OF THE INVENTION

Accordingly, one objective of the present disclosure is to provide an optical system to solve the above problems.

According to some embodiments of the disclosure, an optical system includes a fixed assembly, a movable part and a suspension module. The movable part is configured to be connected to an optical module, and the movable part is movable relative to the fixed assembly. The movable part is movable relative to the fixed assembly through the suspension module.

According to some embodiments, the suspension module includes a first suspension assembly and a second suspension assembly. The movable part is movably connected to the fixed assembly via the first suspension assembly. The first suspension assembly is configured to generate a first restoring force on the movable part. The second suspension assembly is configured to generate a second restoring force on the movable part. The suspension module is configured to generate a total force on the movable part. The total force includes the first restoring force and the second restoring force. When the movable part is in a first position, the first restoring force is a first force. When the movable part is in a second position, the first restoring force is a second force. When the movable part is in a third position, the first restoring force is a third force. The first position is between the second position and the third position. When the movable part is located in the first position, the second restoring force is a fourth force. When the movable part is located in the second position, the second restoring force is a fifth force. When the movable part is located in the third position, the second restoring force is a sixth force. The absolute value of the first force is greater than or equal to the absolute value of the fourth force. The absolute value of the second force is greater than the absolute value of the fifth force. The absolute value of the third force is greater than the absolute value of the sixth force.

The present disclosure provides an optical system, which includes a fixed assembly, a movable part and a suspension module. The movable part is configured to be connected to an optical module, and the movable part is movable relative to the fixed assembly. The movable part moves relative to the fixed assembly via the suspension module. The suspension module may include a first suspension assembly and a second suspension assembly, configured to respectively generate a first restoring force and a second restoring force, which are applied to the movable part.

In some embodiments, the first suspension assembly may include a first elastic member and a second elastic member, and the movable part is suspended in the fixed assembly by the first elastic member and the second elastic member. The second suspension assembly may include a plurality of magnetic elements, one part of which is disposed on the fixed assembly and the other part of which is disposed on the movable part. Based on this configuration, when the optical system is impacted and the movable part shakes relative to the fixed assembly, the resultant force of the first restoring force and the second restoring force can quickly return the movable part to a stable state.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of an optical system 100 according to an embodiment of the present disclosure.

FIG. 2 is an exploded diagram of the optical system 100 according to an embodiment of the present disclosure.

FIG. 3 is a cross-sectional view of the optical system 100 along line A-A in FIG. 1 according to an embodiment of the present disclosure.

FIG. 4 is a top view of a partial structure of the optical system 100 according to an embodiment of the present disclosure.

FIG. 5 to FIG. 7 are schematic front views illustrating that the movable part 108, the first elastic member 106 and the second elastic member 110 are located in different positions according to an embodiment of the present disclosure.

FIG. 8 is a graph showing the first restoring force, the second restoring force and the total force when the movable part 108 is located in different positions according to an embodiment of the present disclosure.

FIG. 9 is a graph illustrating the transmissibility of the optical system 100 according to an embodiment of the present disclosure and a conventional optical system.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

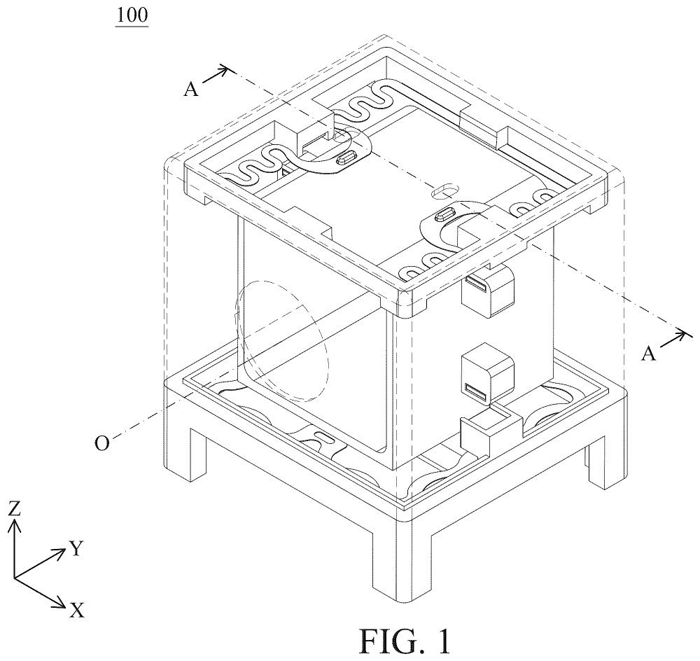

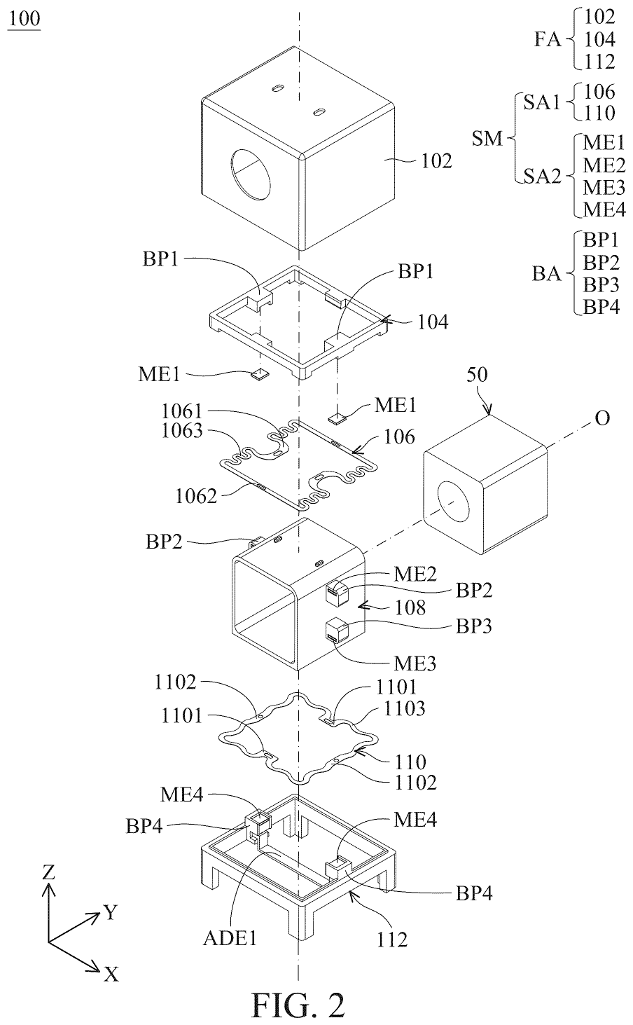

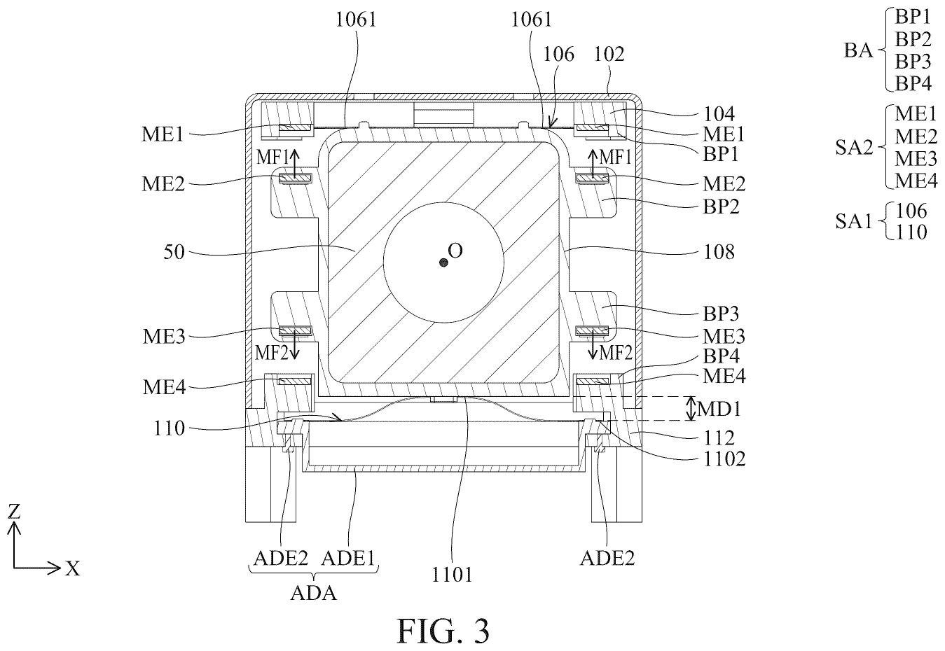

Please refer to FIG. 1 to FIG. 3. FIG. 1 is a perspective view of an optical system 100 according to an embodiment of the present disclosure, FIG. 2 is an exploded diagram of the optical system 100 according to an embodiment of the present disclosure, and FIG. 3 is a cross-sectional view of the optical system 100 along line A-A in FIG. 1 according to an embodiment of the present disclosure. The optical system 100 may be an optical camera module configured to hold and drive an optical element (such as a lens).

The optical system 100 can be installed on various electronic devices or portable electronic devices, such as cars or smart phones, so that users can perform image capturing functions. In this embodiment, the optical system 100 may have an optical anti-shake (OIS) function. Furthermore, the optical system 100 can be implemented in a small size. For example, the optical system 100 can be a cube with a side length of 3 to 5 cm, so that it is more convenient for users to install it in a car or on an electronic product.

In this embodiment, the optical system 100 may include a fixed assembly FA, a movable part 108, and a suspension module SM. The movable part 108 is configured to be connected to an optical module 50, and the movable part 108 is movable relative to the fixed assembly FA. The optical module 50 is, for example, a lens module or a camera module, having at least one of the aforementioned optical elements (such as optical lenses, not shown in the figures), and the optical element can define an optical axis O. Furthermore, the movable part 108 is movable relative to the fixed assembly FA by the suspension module SM.

In this embodiment, as shown in FIG. 2, the fixed assembly FA includes a casing 102, a frame 104 and a base 112. The casing 102 is fixedly connected to the base 112, and the frame 104 is fixedly connected to the casing 102. Furthermore, the suspension module SM may include a first suspension assembly SA1 and a second suspension assembly SA2, and the movable part 108 may be movably connected to the fixed assembly FA via the first suspension assembly SA1.

In this embodiment, the first suspension assembly SA1 is configured to generate a first restoring force on the movable part 108, and the second suspension assembly SA2 is configured to generate a second restoring force on the movable part 108. Therefore, when the optical system 100 is impacted, the first restoring force and the second restoring force can quickly return the movable part 108 to a stable state. The specific operation methods of the first restoring force and the second restoring force will be explained in the following paragraphs.

As shown in FIG. 2, the first suspension assembly SA1 may include a first elastic member 106 and a second elastic member 110. The first elastic member 106 may have a plate-shaped structure, and the first elastic member 106 is connected to the movable part 108 and the frame 104 of the fixed assembly FA. The first elastic member 106 may be parallel to the optical axis O. Specifically, the optical axis O may be perpendicular to the normal vector of the first elastic member 106.

Similarly, the second elastic member 110 may have a plate-shaped structure, and the second elastic member 110 is connected to the movable part 108 and the base 112 of the fixed assembly FA. The second elastic member 110 may be parallel to the first elastic member 106, for example, but it is not limited thereto. The second elastic member 110 and the first elastic member 106 can be made of metal material, but they are not limited thereto.

As shown in FIG. 3, when viewed along the optical axis O, the first elastic member 106 is located on one side of the optical module 50, and the second elastic member 110 is located on the other side of the optical module 50. For example, they are respectively on the upper side and the lower side of the optical module 50 and the movable part 108.

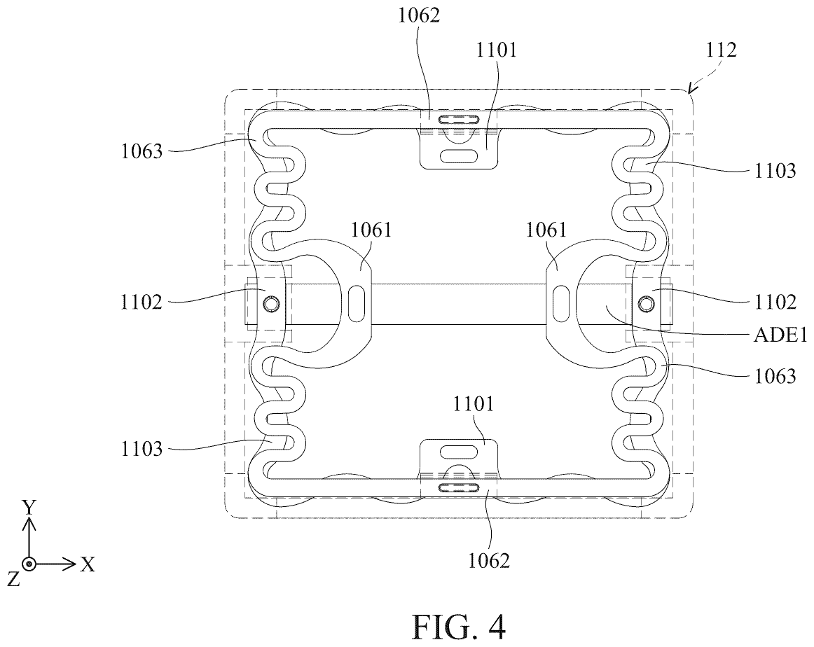

Then please refer to FIGS. 1 to 4. FIG. 4 is a top view of a partial structure of the optical system 100 according to an embodiment of the present disclosure. In this embodiment, the first elastic member 106 has two first inner connection portions 1061, two first outer connection portions 1062 and a plurality of string portions 1063.

The first inner connection portion 1061 is fixedly connected to the movable part 108, the first outer connection portion 1062 is fixedly connected to the frame 104, and the string portion 1063 is connected between the corresponding first inner connection portion 1061 and the first outer connection portion 1062.

Furthermore, in this embodiment, as shown in FIG. 3, the optical system 100 may further include an adjustment assembly ADA configured to adjust the first suspension assembly SA1 of the suspension module SM. The adjustment assembly ADA may include a support connection member ADE1 and two adjustment members ADE2, and the support connection member ADE1 is disposed on the base 112 of the fixed assembly FA.

In this embodiment, as shown in FIG. 2 and FIG. 3, the second elastic member 110 is connected between the support connection member ADE1 and the movable part 108. Similarly, as shown in FIG. 2 and FIG. 4, the second elastic member 110 has two second inner connection portions 1101, two second outer connection portions 1102 and a plurality of string portions 1103.

The second inner connection portion 1101 is fixedly connected to the movable part 108, the second outer connection portion 1102 is fixedly connected to the support connection member ADE1, and the string portion 1103 is connected to between the corresponding second inner connection portion 1101 and the second outer connection portion 1102.

As shown in FIG. 3, the adjustment members ADE2 are movably disposed on the base 112, and the adjustment members ADE2 are, for example, screws that passes through the base 112. The adjustment members ADE2 are configured to contact the support connection member ADE1 to drive the support connection member ADE1 to move up and down along the Z-axis, thereby adjusting a shortest distance MD1 between the second outer connection portion 1102 and the movable part 108.

For example, as shown in FIG. 3, the two adjustment members ADE2 can move up and down along the Z-axis, so that the second elastic member 110 moves up and down along the Z-axis along with the support connection member ADE1, so as to adjust the elastic force exerted by the second elastic member 110 to the movable part 108.

It is worth noting that, as shown in FIG. 4, when viewed in a direction that is perpendicular to the optical axis O, such as viewed as along the Z-axis, the two first inner connection portions 1061 are symmetrical on the left and right sides, the two second inner connection portions 1101 are arranged symmetrically on the up and down sides, and the first inner connection portion 1061 does not overlap the second inner connection portion 1101.

Based on this configuration, when the optical system 100 is impacted, the first restoring force generated by the first elastic member 106 and the second elastic member 110 can assist the movable part 108 to return to the stable state more quickly.

In addition, as shown in FIG. 2 and FIG. 3, the second suspension assembly SA2 may include two first magnetic elements ME1 and two second magnetic elements ME2. The first magnetic elements ME1 are located on the frame 104 of the fixed assembly FA, the second magnetic elements ME2 are located on the movable part 108, and the second magnetic elements ME2 correspond to the first magnetic elements ME1 to generate at least a part of the second restoring force.

Similarly, the second suspension assembly SA2 may further include two third magnetic elements ME3 and two fourth magnetic elements ME4. The third magnetic elements ME3 are located on the movable part 108, the fourth magnetic elements ME4 are located on the base 112 of the fixed assembly FA, and the fourth magnetic elements ME4 corresponds to the third magnetic elements ME3 to generate at least a part of the second restoring force.

In this embodiment, each pair of the first magnetic elements ME1 to the fourth magnetic elements ME4 is arranged in a symmetrical manner, and therefore the following paragraphs will describe only the first magnetic element ME1 to the fourth magnetic element ME4 on a single side.

As shown in FIG. 3, the second magnetic element ME2 and the third magnetic element ME3 on the right side of the movable part 108 are located between the first magnetic element ME1 and the fourth magnetic element ME4.

In this embodiment, these magnetic elements may be magnets. As shown in FIG. 3, a first magnetic attraction force MF1 is generated between the first magnetic element ME1 and the corresponding second magnetic element ME2, and a second magnetic attraction force MF2 is generated between the third magnetic element ME3 and the corresponding fourth magnetic element ME4. The sum of the first magnetic attraction force MF1 and the second magnetic attraction force MF2 is the aforementioned second restoring force.

It is worth noting that in other embodiments, not all of these magnetic elements are magnets. For example, the second magnetic element ME2 and the third magnetic element ME3 can be magnets, and the first magnetic element ME1 and the fourth magnetic element ME4 can be magnetic conductive plates. That is, as long as the first magnetic element ME1 and the second magnetic element ME2 can attract each other, and the third magnetic element ME3 and the fourth magnetic element ME4 can attract each other, the configuration is within the scope of the present disclosure.

Furthermore, in this embodiment, as shown in FIG. 2 and FIG. 3, the optical system 100 may further include a blocking assembly BA configured to limit the movable part 108 to move within a range of motion. When the movable part 108 is located in any position within the range of motion, the gap between the first magnetic element ME1 and the second magnetic element ME2 is greater than 0. The movement of the movable part 108 is, for example, up and down movement along the Z-axis.

Specifically, when the movable part 108 is located in any position within the range of motion, the shortest distance between the first magnetic element ME1 and the second magnetic element ME2 is greater than 1 mm so as to ensure that the first magnetic element ME1 and the second magnetic element ME2 do not attract and lock onto each other.

Similarly, when the movable part 108 is located in any position within the range of motion, the gap between the third magnetic element ME3 and the fourth magnetic element ME4 is greater than 0. Specifically, when the movable part 108 is located in any position within the range of motion, the shortest distance between the third magnetic element ME3 and the fourth magnetic element ME4 is greater than 1 mm.

In order to achieve the above configuration, the blocking assembly BA may include a first blocking portion BP1 and a second blocking portion BP2. The first blocking portion BP1 is located on the frame 104 of the fixed assembly FA, and the second blocking portion BP2 is located on the movable part 108. The first magnetic element ME1 and the second magnetic element ME2 are respectively disposed in the first blocking portion BP1 and the second blocking portion BP2.

Correspondingly, the blocking assembly BA may further include a third blocking portion BP3 and a fourth blocking portion BP4. The third blocking portion BP3 is located on the movable part 108, and the fourth blocking portion BP4 is located on the base 112 of the fixed assembly FA. The third magnetic element ME3 and the fourth magnetic element ME4 are respectively disposed in the third blocking portion BP3 and the fourth blocking portion BP4.

The second blocking portion BP2 and the third blocking portion BP3 are protrusions on the movable part 108 and are configured to contact the first blocking portion BP1 and the fourth blocking portion BP4 respectively. Based on this configuration, the first blocking portion BP1 and the second blocking portion BP2 can ensure that the shortest distance between the first magnetic element ME1 and the second magnetic element ME2 is greater than 1 mm, and the third blocking portion BP3 and the fourth blocking portion BP4 can ensure that the shortest distance between the third magnetic element ME3 and the fourth magnetic element ME4 is greater than 1 mm.

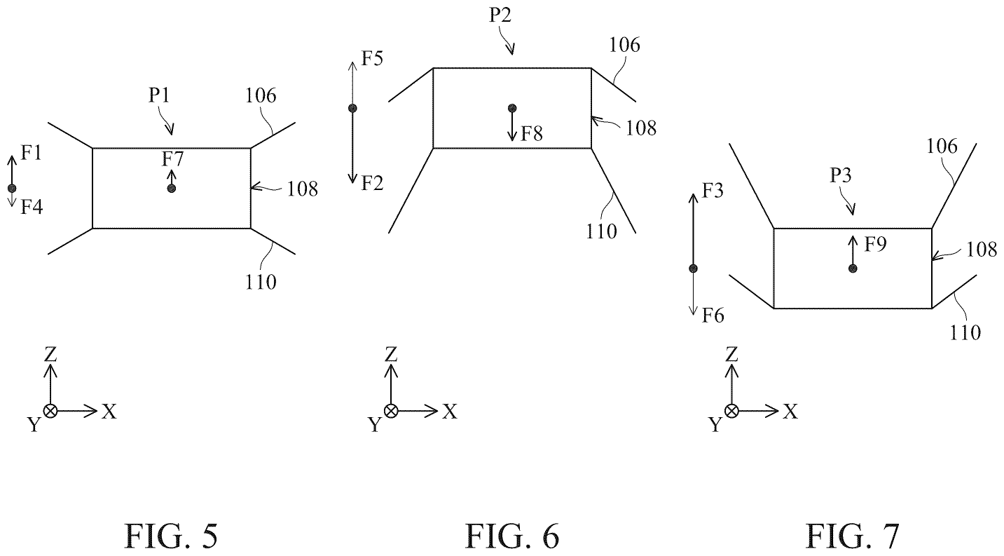

Next, please refer to FIG. 5 to FIG. 7. FIG. 5 to FIG. 7 are schematic front views illustrating that the movable part 108, the first elastic member 106 and the second elastic member 110 are located in different positions according to an embodiment of the present disclosure. When the optical system 100 is impacted or shaken, the movable part 108 may move back and forth along the Z-axis. At this time, the suspension module SM is configured to generate a total force onto the movable part 108 so that the movable part 108 can quickly return to the stable state (such as stationary relative to fixed assembly FA).

The total force includes the aforementioned first restoring force and the second restoring force. That is, the total force is the sum of the first restoring force and the second restoring force.

As shown in FIG. 5 to FIG. 7, when the movable part 108 is located in a first position P1 in FIG. 5, the first restoring force can be a first force F1. When the movable part 108 is located in a second position P2 in FIG. 6, the first restoring force can be a second force F2. When the movable part 108 is located in a third position P3 in FIG. 7, the first restoring force is a third force F3.

That is, the first restoring force changes its size and direction according to the position of the movable part 108. The first position P1 is located between the second position P2 and the third position P3, such as an intermediate position between the second position P2 and the third position P3, but it is not limited thereto. Furthermore, the second position P2 may be a first extreme position of the range of motion of the movable part 108, and the third position P3 may be a second extreme position of the range of motion of the movable part 108, but they are not limited thereto.

It should be noted that, for the sake of clear explanation, in FIG. 5 to FIG. 7, the two elastic restoring forces provided by the first elastic member 106 and the second elastic member 110 are only represented by their resultant force (the first restoring force).

Similarly, when the movable part 108 is located in the first position P1, the second restoring force is a fourth force F4, when the movable part 108 is located in the second position P2, the second restoring force is a fifth force F5, and when the movable part 108 is located in the third position P3, the second restoring force is a sixth force F6.

That is, the second restoring force also changes its size and direction according to the position of the movable part 108. In addition, it should be noted that for the sake of clear explanation, the magnetic attraction force provided by the first magnetic attraction force MF1 and the second magnetic attraction force MF2 in FIG. 3 are represented by their resultant force (the second restoring force) in FIG. 5 to FIG. 7.

The absolute value of the first force F1 is greater than or equal to the absolute value of the fourth force F4, the absolute value of the second force F2 is greater than the absolute value of the fifth force F5, and the absolute value of the third force F3 is greater than the absolute value of the sixth force F6.

For example, when the movable part 108 is located in the first position in FIG. 5 due to shaking, the movable part 108 can be located in the intermediate position between the second position P2 and the third position P3. At this time, the absolute value of the first force F1 may be slightly greater than or equal to the absolute value of the fourth force F4, thereby reducing the amplitude of the movable part 108 moving upward or downward.

Furthermore, when the movable part 108 moves upward to the second position P2 in FIG. 6, because the first elastic member 106 provides a greater elastic restoring force, the absolute value of the second force F2 will be greater than the absolute value of first force F1.

In addition, it is worth noting that when the movable part 108 moves upward to the second position P2 (the first extreme position) in FIG. 6, the second blocking portion BP2 in FIG. 3 is configured to contact the first blocking portion BP1 so as to limit the movable part 108 to be within the aforementioned range of motion.

Similarly, when the movable part 108 moves downward to the third position P3 (the second extreme position) in FIG. 7, because the second elastic member 110 provides a greater elastic restoring force, the absolute value of the third force F3 will be greater than the absolute value of the first force F1. The direction of the second force F2 is opposite to the direction of the third force F3.

Similarly, when the movable part 108 moves downward to the third position P3 (the second extreme position) in FIG. 7, the third blocking portion BP3 in FIG. 3 is configured to contact the fourth blocking portion BP4 so as to limit the movable part 108 to be within the aforementioned range of motion.

On the other hand, when the movable part 108 moves upward to the second position P2 in FIG. 6, because the first magnetic element ME1 and the second magnetic element ME2 provide a greater magnetic attraction force, the absolute value of the fifth force F5 will be greater than the absolute value of the fourth force F4.

Similarly, when the movable part 108 moves downward to the third position P3 in FIG. 7, because the third magnetic element ME3 and the fourth magnetic element ME4 provide a greater magnetic attraction force, the absolute value of the sixth force F6 will be greater than the absolute value of the fourth force F4. The direction of the fifth force F5 is opposite to the direction of the sixth force F6.

It is worth noting that, in order to help the shaken movable part 108 to quickly return to the stable state, the absolute value of the fifth force F5 in this embodiment is at least greater than half of the absolute value of the second force F2, and the absolute value of the sixth force F6 is at least greater than half of the absolute value of the third force F3. The direction of the second force F2 is opposite to the direction of the fifth force F5, and the direction of the third force F3 is opposite to the direction of the sixth force F6.

Furthermore, in this embodiment, when the movable part 108 is located in the first position P1, the total force is a seventh force F7, and the seventh force F7 is the resultant force of the first force F1 and the fourth force F4.

When the movable part 108 is located in the second position P2, the total force is an eighth force F8, and the eighth force F8 is the resultant force of the second force F2 and the fifth force F5. When the movable part 108 is located in the third position P3, the total force is a ninth force F9, and the ninth force F9 is the resultant force of the third force F3 and the sixth force F6.

The absolute value of the eighth force F8 is greater than the absolute value of the seventh force F7, and the absolute value of the ninth force F9 is greater than the absolute value of the seventh force F7. The direction of the eighth force F8 is opposite to the direction of the ninth force F9.

Furthermore, the absolute value of the eighth force F8 is less than the absolute value of the second force F2, and the direction of the eighth force F8 is the same as the direction of the second force F2. Similarly, the absolute value of the ninth force F9 is less than the absolute value of the third force F3, and the direction of the ninth force F9 is the same as the direction of the third force F3.

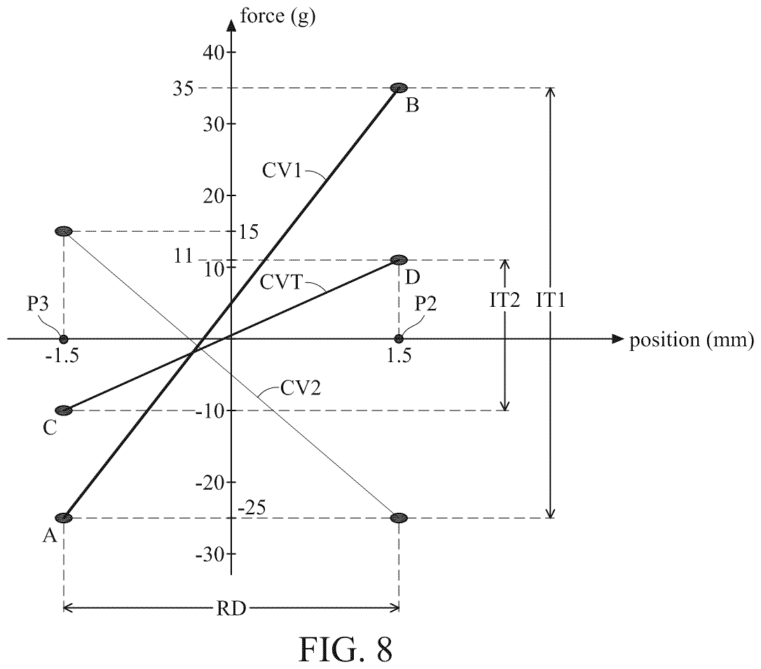

Next, please refer to FIG. 8. FIG. 8 is a graph showing the first restoring force, the second restoring force and the total force when the movable part 108 is located in different positions according to an embodiment of the present disclosure. The line segment CV1 represents the magnitude of the first restoring force in different positions, the line segment CV2 represents the magnitude of the second restoring force in different positions, and the line segment CVT represents the magnitude of the total force in different positions.

As shown in FIG. 8, the end point A of the line segment CV1 represents the force in the third position P3 (the third force F3), and the end point B of the line segment CV1 represents the force in the second position P2 (the second force F2), and there is a first difference value IT1 (on the vertical axis) between the second force F2 and the third force F3.

Similarly, the end point C of the line segment CVT represents the force in the third position (the ninth force F9), the end point D of the line segment CVT represents the force in the second position (the eighth force F8), and the there is a second difference value IT2 (on the vertical axis) between the eighth force F8 and the ninth force F9.

As shown in FIG. 8, the first difference value IT1 is greater than the second difference value IT2. That is, after adding the second restoring force, the magnitude of the first restoring force can be reduced.

Furthermore, as shown in FIG. 8, a shortest distance RD is formed between the second position P2 and the third position P3. In this embodiment, the shortest distance RD is, for example, 3 mm, but it is not limited thereto. The first difference value IT1 and the shortest distance RD can form a first slope, the second difference value IT2 and the shortest distance RD can form a second slope, and the first slope is greater than the second slope.

That is, between the second position P2 and the third position P3, the total force exerted on the movable part 108 is relatively gentle, so that the movable part 108 can quickly reach a stable state after being shaken.

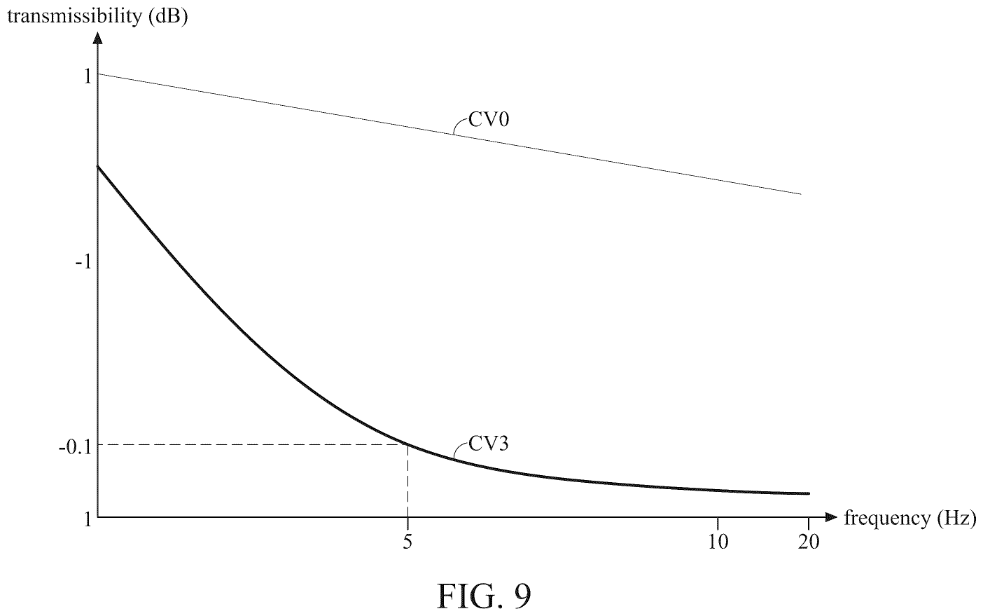

Next, please refer to FIG. 9. FIG. 9 is a graph illustrating the transmissibility of the optical system 100 according to an embodiment of the present disclosure and a conventional optical system. As shown in FIG. 9, the curve CV3 represents the transmissibility curve of the optical system 100 of the present disclosure, and the curve CV0 represents the transmissibility curve of the conventional optical system. Transmissibility can be defined as input/output. The input is the displacement of the optical system when it is shaken, and the output is the displacement of the movable part when the optical system is shaken.

In FIG. 9, as shown by the curve CV0, at different frequencies, the displacement amount transmitted by the optical system to the movable part is greater. That is, the conventional movable part is not easy to reach a stable state when shaken.

On the other hand, as shown in the curve CV3, in the present disclosure, based on the configuration of the suspension module SM, the transmissibility drops sharply in the frequency range above 5 Hz. That is, the movable part 108 of the present disclosure can quickly reach a stable state when shaken, and is not easily affected by external forces acting on it. Therefore, the optical module 50 carried by the movable part 108 can still capture clear images even when the optical system 100 is shaken.

In conclusion, the present disclosure provides an optical system 100, which includes a fixed assembly FA, a movable part 108 and a suspension module SM. The movable part 108 is configured to be connected to an optical module 50, and the movable part 108 is movable relative to the fixed assembly FA. The movable part 108 moves relative to the fixed assembly FA via the suspension module SM. The suspension module SM may include a first suspension assembly SA1 and a second suspension assembly SA2, configured to respectively generate a first restoring force and a second restoring force, which are applied to the movable part 108.

In some embodiments, the first suspension assembly SA1 may include a first elastic member 106 and a second elastic member 110, and the movable part 108 is suspended in the fixed assembly FA by the first elastic member 106 and the second elastic member 110. The second suspension assembly SA2 may include a plurality of magnetic elements, one part of which is disposed on the fixed assembly FA and the other part of which is disposed on the movable part 108. Based on this configuration, when the optical system 100 is impacted and the movable part 108 shakes relative to the fixed assembly FA, the resultant force of the first restoring force and the second restoring force can quickly return the movable part 108 to a stable state.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical system, comprising:
a fixed assembly;
a movable part, configured to be connected to an optical module, wherein the movable part is movable relative to the fixed assembly; and
a suspension module, wherein the movable part is movable relative to the fixed assembly by the suspension module.

2. The optical system as claimed in claim 1, wherein
the suspension module includes a first suspension assembly and a second suspension assembly;
the movable part is movably connected to the fixed assembly via the first suspension assembly;
the first suspension assembly is configured to generate a first restoring force on the movable part;
the second suspension assembly is configured to generate a second restoring force on the movable part;
the suspension module is configured to generate a total force on the movable part; and
the total force includes the first restoring force and the second restoring force.

3. The optical system as claimed in claim 2, wherein
when the movable part is in a first position, the first restoring force is a first force;
when the movable part is in a second position, the first restoring force is a second force;
when the movable part is in a third position, the first restoring force is a third force;
the first position is between the second position and the third position;
when the movable part is located in the first position, the second restoring force is a fourth force;
when the movable part is located in the second position, the second restoring force is a fifth force;
when the movable part is located in the third position, the second restoring force is a sixth force;
an absolute value of the first force is greater than or equal to an absolute value of the fourth force;
an absolute value of the second force is greater than an absolute value of the fifth force; and
an absolute value of the third force is greater than an absolute value of the sixth force.

4. The optical system as claimed in claim 3, wherein
the absolute value of the second force is greater than the absolute value of the first force;
the absolute value of the third force is greater than the absolute value of the first force;
a direction of the second force is opposite to a direction of the third force;
the absolute value of the fifth force is greater than the absolute value of the fourth force;
the absolute value of the sixth force is greater than the absolute value of the fourth force; and
a direction of the fifth force is opposite to a direction of the sixth force.

5. The optical system as claimed in claim 4, wherein
the direction of the second force is opposite to the direction of the fifth force;
the absolute value of the fifth force is at least greater than half of the absolute value of the second force;
the direction of the third force is opposite to the direction of the sixth force; and
the absolute value of the sixth force is at least greater than half of the absolute value of the third force.

6. The optical system as claimed in claim 5, wherein
when the movable part is located in the first position, the total force is a seventh force;
when the movable part is located in the second position, the total force is an eighth force;
when the movable part is located in the third position, the total force is a ninth force;
an absolute value of the eighth force is greater than an absolute value of the seventh force;
an absolute value of the ninth force is greater than the absolute value of the seventh force; and
a direction of the eighth force is opposite to a direction of the ninth force.

7. The optical system as claimed in claim 6, wherein
the absolute value of the eighth force is less than the absolute value of the second force;
the direction of the eighth force is the same as the direction of the second force;
an absolute value of the ninth force is less than the absolute value of the third force; and
the direction of the ninth force is the same as the direction of the third force.

8. The optical system as claimed in claim 7, wherein
there is a first difference value between the second force and the third force;
there is a second difference value between the eighth force and the ninth force; and
the first difference value is greater than the second difference value.

9. The optical system as claimed in claim 8, wherein
a shortest distance is formed between the second position and the third position;
the first difference value and the shortest distance form a first slope;
the second difference value and the shortest distance form a second slope; and
the first slope is greater than the second slope.

10. The optical system as claimed in claim 3, wherein
the first suspension assembly includes a first elastic member and a second elastic member;
the first elastic member has a plate-shaped structure, and the first elastic member is connected to the movable part and the fixed assembly;
the optical module has an optical element, and the optical element defines an optical axis;
the first elastic member is parallel to the optical axis; and
the optical axis is perpendicular to a normal vector of the first elastic member.

11. The optical system as claimed in claim 10, wherein
the second elastic member has a plate-shaped structure, and the second elastic member is connected to the movable part and the fixed assembly; and
when viewed along the optical axis, the first elastic member is located on one side of the optical module, and the second elastic member is located on the other side of the optical module.

12. The optical system as claimed in claim 11, wherein
the second suspension assembly includes a first magnetic element and a second magnetic element;
the first magnetic element is located on the fixed assembly;
the second magnetic element is located on the movable part; and
the second magnetic element corresponds to the first magnetic element to generate at least part of the second restoring force.

13. The optical system as claimed in claim 12, wherein
the second suspension assembly further includes a third magnetic element and a fourth magnetic element;
the third magnetic element is located on the movable part;
the fourth magnetic element is located on the fixed assembly;
the fourth magnetic element corresponds to the third magnetic element to generate at least part of the second restoring force; and
the second magnetic element and the third magnetic element are located between the first magnetic element and the fourth magnetic element.

14. The optical system as claimed in claim 13, wherein
the optical system further includes a blocking assembly configured to limit the movable part to move within a range of motion;
when the movable part is located in any position within the range of motion, a gap between the first magnetic element and the second magnetic element is greater than 0; and
when the movable part is located in any position within the range of motion, a shortest distance between the first magnetic element and the second magnetic element is greater than 1 mm.

15. The optical system as claimed in claim 14, wherein
when the movable part is located in any position within the range of motion, a gap between the third magnetic element and the fourth magnetic element is greater than 0; and
when the movable part is located in any position within the range of motion, a shortest distance between the third magnetic element and the fourth magnetic element is greater than 1 mm.

16. The optical system as claimed in claim 15, wherein
the blocking assembly includes a first blocking portion and a second blocking portion;
the first blocking portion is located on the fixed assembly;
the second blocking portion is located on the movable part;
when the movable part is located in a first extreme position, the second blocking portion is configured to contact the first blocking portion so as to limit the movable part to be within the range of motion; and
the first magnetic element and the second magnetic element are respectively disposed in the first blocking portion and the second blocking portion.

17. The optical system as claimed in claim 16, wherein
the blocking assembly includes a third blocking portion and a fourth blocking portion;
the third blocking portion is located on the movable part;
the fourth blocking portion is located on the fixed assembly;
when the movable part is located in a second extreme position, the third blocking portion is configured to contact the fourth blocking portion to limit the movable part to be within the range of motion; and
the third magnetic element and the fourth magnetic element are respectively disposed in the third blocking portion and the fourth blocking portion.

18. The optical system as claimed in claim 11, wherein
the fixed assembly has a casing, a frame and a base;
the casing is fixedly connected to the base;
the frame is fixedly connected to the casing;
the first elastic member has a first inner connection portion and a first outer connection portion;
the first inner connection portion is fixedly connected to the movable part; and
the first outer connection portion is fixedly connected to the frame.

19. The optical system as claimed in claim 18, wherein
the optical system further includes an adjustment assembly configured to adjust the first suspension assembly of the suspension module;
the adjustment assembly includes a support connection member and an adjustment member;
the support connection member is disposed on the base;
the second elastic member is connected between the support connection member and the movable part;
the second elastic member has a second inner connection portion and a second outer connection portion;
the second inner connection portion is fixedly connected to the movable part; and
the second outer connection portion is fixedly connected to the support connection member.

20. The optical system as claimed in claim 19, wherein
when viewed in a direction perpendicular to the optical axis, the first inner connection portion does not overlap the second inner connection portion;
the adjustment member is movably disposed on the base; and
the adjustment member is configured to contact the support connection member and is configured to adjust a shortest distance between the second outer connection portion and the movable part.
